(19) United States
(12) Patent Application Publication
(10) Pub. No.: US 2018/0227992 A1
(43) Pub. Date: Aug. 9, 2018

(54) OPTOELECTRONIC CIRCUIT WITH LIGHT-EMITTING DIODES

(71) Applicants: Aledia, Grenoble (FR); Easii IC, Grenoble (FR)

(72) Inventors: Frédéric Mercier, Saint Nicolas De Macherin (FR); David Gras, Echirolles (FR); Nicolas Joubert, Grenoble (FR)

(73) Assignees: Aledia, Grenoble (FR); Easii IC, Grenoble (FR)

(21) Appl. No.: 15/750,172

(22) PCT Filed: Jul. 19, 2016
(86) PCT No.: PCT/FR2016/051843

§ 371 Date: Feb. 2, 2018

(30) Foreign Application Priority Data
Aug. 3, 2015 (FR) 1557480

(51) Int. Cl. H05B 33/08

(52) U.S. Cl. CPC H05B 33/0815; H05B 33/0824

(57) ABSTRACT

An optoelectronic circuit for receiving a variable voltage containing alternating increasing and decreasing phases. The optoelectronic circuit includes assemblies of light-emitting diodes mounted in series; a current source connected to each assembly by a switch; for each switch, a first comparison module for comparing the current passing through the switch with a current threshold; a second comparison module for comparing a voltage representing the voltage at the terminals of the current source with a voltage threshold; and a control module connected to the first and second comparison modules and designed to control the opening and closing of the switches, during each increasing phase and each decreasing phase, according to signals supplied by the first and second comparison modules.

The present patent application claims the priority benefit of French patent application FR15/57480 which is herein incorporated by reference.

### BACKGROUND

The present description relates to an optoelectronic circuit, particularly to an optoelectronic circuit comprising light-emitting diodes.

### DISCUSSION OF THE RELATED ART

It is desirable to be able to power an optoelectronic circuit comprising light-emitting diodes with an AC voltage, particularly a sinusoidal voltage, for example, the mains voltage.

FIG. 1 shows an example of an optoelectronic circuit 10 comprising input terminals IN₁ and IN₂ having an AC voltage V_{IN} applied therebetween. Optoelectronic circuit 10 further comprises a rectifying circuit 12 comprising a diode bridge 14, receiving voltage V_{IN} and supplying a rectified voltage V_{ALIM} which powers light-emitting diodes 16, for example, series-assembled with a resistor 15. Call I_{ALIM} the current flowing through light-emitting diodes 16.

FIG. 2 is a timing diagram of power supply voltage V_{ALIM} and of power supply current I_{ALIM} for an example where AC voltage V_{IN} corresponds to a sinusoidal voltage. When voltage V_{ALIM} is greater than the sum of the threshold voltages of light-emitting diodes 16, light-emitting diodes 16 become conductive. Power supply current I_{ALIM} then follows power supply voltage V_{ALIM} There thus is an alternation of phases OFF without light emission and of light-emission phases ON.

A disadvantage is that as long as voltage V_{ALIM} is smaller than the sum of the threshold voltages of light-emitting diodes 16, no light is emitted by optoelectronic circuit 10. An observer may perceive this lack of light emission when the duration of each phase OFF with no light emission between two light-emission phases ON is too long. A possibility, to increase the duration of each phase ON, is to decrease the number of light-emitting diodes 16. A disadvantage then is that the electric power lost in the resistor is significant.

Publication US 2012/0056559 describes an optoelectronic circuit where the number of light-emitting diodes receiving power supply voltage V_{ALIM} progressively increases during a rising phase of the power supply voltage and progressively decreases during a falling phase of the power supply voltage. This is achieved by a switching circuit capable of short-circuiting a variable number of light-emitting diodes according to the variation of voltage V_{ALIM} This enables to decrease the duration of each phase with no light emission.

A disadvantage of the optoelectronic circuit described in publication US 2012/0056559 is that the light-emitting diode power supply current does not continuously vary, that is, there are abrupt interruptions of the current flow during the voltage variation. This causes time variations of the light intensity supplied by the light-emitting diodes, which may be perceived by an observer. This further causes a degradation of the harmonic factor of the current powering the light-emitting diodes of the optoelectronic circuit.

### SUMMARY

An object of an embodiment is to overcome all or part of the disadvantages of the previously-described optoelectronic circuits.

Another object of an embodiment is to decrease the duration of phases during which no light is emitted by the optoelectronic circuit.

Another object of an embodiment is for the current powering the light-emitting diodes to vary substantially continuously.

Thus, an embodiment provides an optoelectronic circuit intended to receive a variable voltage containing an alternation of rising and falling phases, the optoelectronic circuit comprising:

a plurality of assemblies of light-emitting diodes, said assemblies being series-assembled;

a current source connected to each assembly, among at least certain assemblies from the plurality of assemblies, by a switch;

for each switch, a first comparison unit capable of comparing the current flowing through the switch with a current threshold;

a second unit for comparing a voltage representative of the voltage across the current source with a voltage threshold;

a control unit connected to the first and second comparison units and capable, during each rising phase and each falling phase, of controlling the switches to the off and on state according to signals supplied by the first and second comparison units.

According to an embodiment, the control unit is capable, during each rising phase, for each switch, of controlling said switch to the off state when the current flowing through the adjacent switch in the on state rises above the current threshold and, during each falling phase, for each off switch adjacent to a switch in the on state, of controlling said switch to the on state when said voltage falls below the voltage threshold.

According to an embodiment, the current source is capable of supplying a current having its intensity depending on at least one control signal.

According to an embodiment, the current source is capable of supplying a current having its intensity varying among a plurality of different intensity values according to the number of assemblies conducting said current during at least one rising or falling phase.

According to an embodiment, the optoelectronic circuit is capable of receiving a modulation signal external to the optoelectronic circuit and the current source is capable of modifying said intensity values according to said modulation signal.

According to an embodiment, the current source comprises elementary current sources assembled in parallel and capable of being activated and deactivated independently from one another.

According to an embodiment, the elementary current sources are capable of supplying currents having the same intensity or having different intensities.

According to an embodiment, the control unit is capable of activating at least one of the elementary current sources during at least one rising phase and is capable of deactivating at least one of the elementary current sources during at least one falling phase.

According to an embodiment, one of the elementary current sources is capable of supplying a current having a given intensity and the other elementary current sources are capable of each supplying a current having an intensity equal to the product a power of two and of said given intensity.

According to an embodiment, the control unit is capable of controlling the switches to connect the assemblies of light-emitting diodes according to a plurality of connection configurations successively according to a first order during each rising phase of the variable voltage and a second order during each falling phase of the variable voltage and is capable of activating the elementary current sources according to a third order during each rising phase of the variable voltage and of deactivating the elementary current sources according to a fourth order during each rising phase of the variable voltage.

According to an embodiment, the optoelectronic circuit comprises a memory having a plurality of values of the control signal of the current source, each corresponding to the provision by the current source of a current having its intensity varying among said plurality of intensity values, stored therein.

According to an embodiment, the optoelectronic circuit comprises means for modifying the variation profile of the intensity of said current according to the number of assemblies conducting said current during at least one rising or falling phase.

Another embodiment provides a method of controlling a plurality of assemblies of light-emitting diodes, said assemblies being series-assembled and powered with a variable voltage, containing an alternation of rising and falling phases, each assembly among at least certain assemblies from the plurality of assemblies being connected to a current source by a switch, the method comprising the steps of:

for each switch, comparing the current flowing through the switch with a current threshold;

comparing a voltage representative of the voltage across the current source with a voltage threshold; and

during each rising phase and each falling phase, controlling the switches to the off and on state according to signals supplied by the first and second comparison units.

According to an embodiment, the method further comprises the step of:

during each rising phase, for each switch, turning off said switch when the current flowing through the adjacent switch in the on state rises above the current threshold and, during each falling phase, for each off switch adjacent to a switch in the on state, turning on said switch when said voltage falls below the voltage threshold.

According to an embodiment, the current source comprises at least two elementary current sources assembled in parallel and at least one of the elementary current sources is activated during at least one rising phase and at least one of the elementary current sources is deactivated during at least one falling phase.

According to an embodiment, the current source comprises at least three elementary current sources assembled in parallel, wherein, for at least successive rising and falling phases, the number of activated elementary current sources increases from the beginning to the end of the rising phase and the number of activated elementary current sources decreases from the beginning to the end of the falling phase or wherein the number of activated elementary current sources increases and then decreases from the beginning to the end of the rising phase and the number of activated elementary current sources increases and then decreases from the beginning to the end of the falling phase.

### BRIEF DESCRIPTION OF THE DRAWINGS

The foregoing and other features and advantages will be discussed in detail in the following non-limiting description of specific embodiments in connection with the accompanying drawings, among which:

FIG. 1, previously described, is an electric diagram of an example of an optoelectronic circuit comprising light-emitting diodes;

FIG. 2, previously described, is a timing diagram of the power supply voltage and current of the light-emitting diodes of the optoelectronic circuit of FIG. 1;

FIG. 3 shows an electric diagram of an embodiment of an optoelectronic circuit comprising light-emitting diodes;

FIGS. 4 and 5 illustrate two layouts of the light-emitting diodes of the optoelectronic circuit of FIG. 3;

FIGS. 6 to 9 show more detailed electric diagrams of embodiments of portions of the optoelectronic circuit of FIG. 3;

FIG. 10 is a timing diagram of voltages and of currents of the optoelectronic circuit of FIG. 3;

FIG. 11 shows an electric diagram of another embodiment of the current source of the optoelectronic circuit of FIG. 3;

FIGS. 12A and 12B are timing diagrams of voltages and of currents of the optoelectronic circuit of FIG. 3 for two embodiments of a method of controlling the current source of the optoelectronic circuit;

FIGS. 13 to 17 show electric diagrams of other embodiments of the current source of the optoelectronic circuit of FIG. 3; and

FIGS. 18 and 19 show curves of the variation, obtained by simulation, of voltages and of currents of the optoelectronic circuit of FIG. 3 for two embodiments of the method of controlling the current source of the optoelectronic circuit.

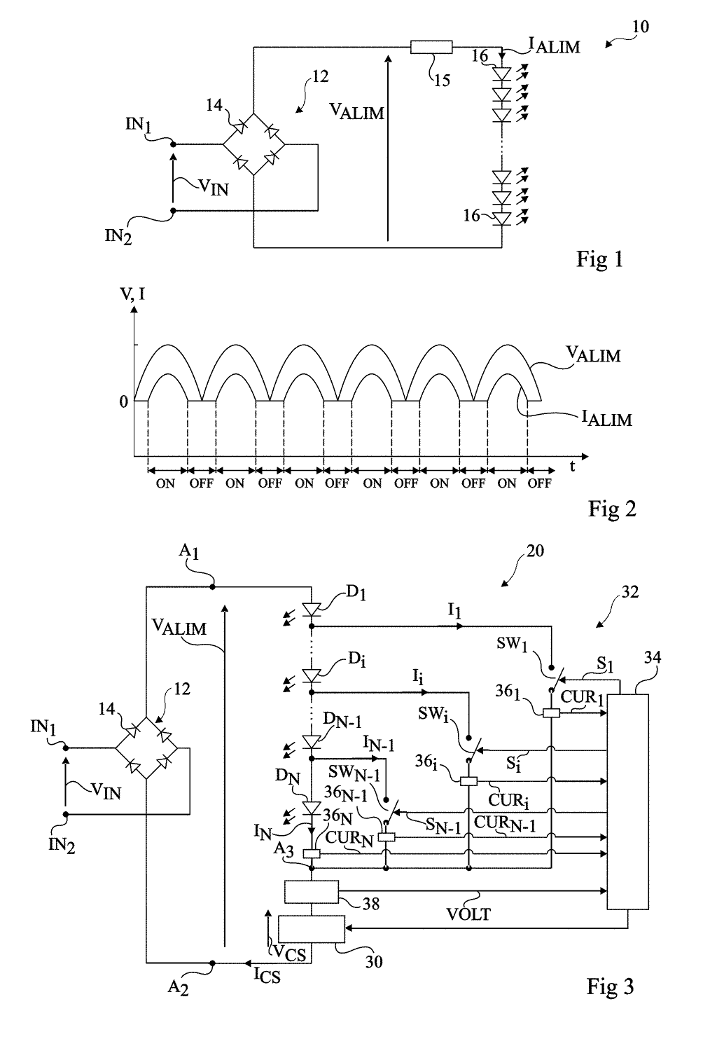

### DETAILED DESCRIPTION

For clarity, the same elements have been designated with the same reference numerals in the various drawings and, further, the various drawings are not to scale. Unless otherwise specified, expressions “approximately”, “substantially”, and “in the order of” mean to within 10%, preferably to within 5%. In the following description, the ratio of the active power consumed by the electronic circuit to the product of the effective values of the current and of the voltage powering the electronic circuit is called “power factor”.

FIG. 3 shows an electric diagram of an embodiment of an optoelectronic circuit 20 comprising a light-emitting diode switching device. The elements of optoelectronic circuit 20 common with optoelectronic circuit 10 are designated with the same reference numerals. In particular, optoelectronic circuit 20 comprises rectifying circuit 12 receiving power supply voltage V_{IN} between terminals IN₁ and IN₂ and supplying rectified voltage V_{ALIM} between nodes A₁ and A₂. As a variation, circuit 20 may directly receive a rectified voltage, and it is then possible for the rectifying circuit not to be present. The potential at node A₂ may correspond to the low reference potential having the voltages of optoelectronic circuit 20 referenced thereto.

Optoelectronic circuit 20 comprises N series-connected assemblies of elementary light-emitting diodes, called general light-emitting diodes Dᵢ in the following description, where i is an integer in the range from 1 to N and where N is an integer in the range from 2 to 200. Each general light-emitting diode D₁ to D_{N} comprises at least one elementary light-emitting diode and is preferably formed of the series and/or parallel assembly of at least two elementary light-emitting diodes. In the present example, the N general light-emitting diodes Dᵢ are series-connected, the cathode of general light-emitting diode Dᵢ being coupled to the anode of general light-emitting diode Dᵢ₊₁, for i varying from 1 to N−1. The anode of general light-emitting diode D₁ is coupled to node A₁. General light-emitting diodes Dᵢ, with i varying from 1 to N, may comprise the same number of elementary light-emitting diodes or different numbers of elementary light-emitting diodes.

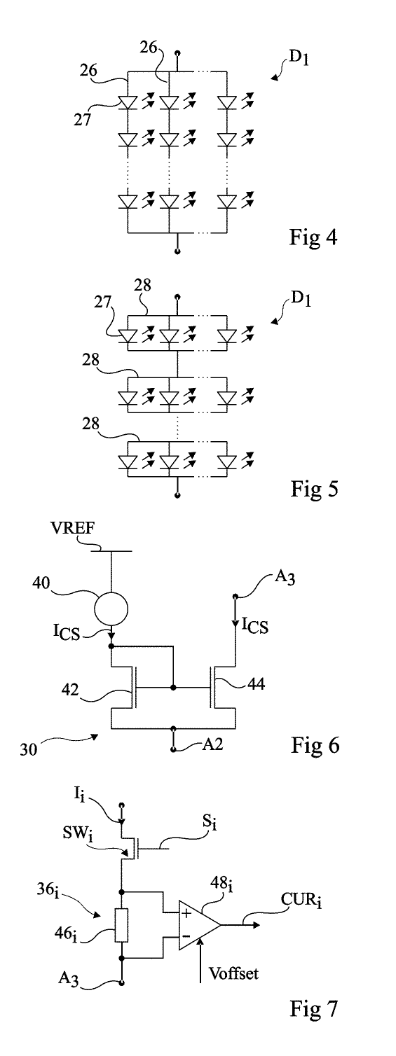

FIG. 4 shows an embodiment of general light-emitting diode D₁ where general light-emitting diode D₁ comprises R branches 26 assembled in parallel, each branch comprising S elementary light-emitting diodes 27 series-assembled in the same conduction direction, R and S being integers greater than or equal to 1.

FIG. 5 shows another embodiment of general light-emitting diode D₁ where general light-emitting diode D₁ comprises P series-assembled blocks 28, each block comprising Q elementary light-emitting diodes 27 assembled in parallel, P and Q being integers greater than or equal to 1 and Q being likely to vary from one block to the other.

The other general light-emitting diodes D₂ to D_{N} may have a structure similar to that of general light-emitting diode D₁ shown in FIG. 4 or 5.

Elementary light-emitting diodes 27 are, for example, planar light-emitting diodes, each comprising a stack of layers laid on a planar surface, having at least one active layer capable of emitting light. Elementary light-emitting diodes 27 are, for example, light-emitting diodes formed from three-dimensional semiconductor elements, particularly microwires, nanowires, or pyramids, for example comprising a semiconductor material based on a compound mainly comprising at least one group-III element and one group-V element (for example, gallium nitride GaN), called III-V general hereafter, or mainly comprising at least one group-II element and one group-VI element (for example, zinc oxide ZnO), called II-VI general hereafter. Each three-dimensional semiconductor element is covered with an active layer capable of emitting light.

Referring back to FIG. 3, optoelectronic circuit 20 comprises a current source 30 having a terminal connected to node A₂ and having its other terminal connected to a node A3. Call V_{CS} the voltage across current source 30 and I_{CS} the current supplied by current source 30. Optoelectronic circuit 20 may comprise a circuit, not shown, which supplies a reference voltage to power the current source, possibly obtained from voltage V_{ALIM}.

Circuit 20 comprises a device 32 for switching general light-emitting diodes Dᵢ, with i varying from 1 to N. As an example, device 32 comprises N−1 controllable switches SW₁ to SW_{N-1}. Each switch SWᵢ, with i varying from 1 to N−1, is assembled between node A₃ and the cathode of general light-emitting diode Dᵢ. Each switch SWᵢ, with i varying from 1 to N−1, is controlled by a signal Sᵢ supplied by a control unit 34. For i varying from 1 to N−1, call Iᵢ the current flowing through switch SWᵢ and call I_{N} the current flowing through general light-emitting diode D_{N}. As a variation, a switch may further be present between the cathode of general light-emitting diode D_{N} and node A₃.

According to an embodiment, current source 30 is also controlled by control unit 34. Control unit 34 may totally or partly be formed by a dedicated circuit or may comprise a microprocessor or a microcontroller capable of executing a sequence of instructions stored in a memory. As an example, signal Sᵢ is a binary signal and switch SWᵢ is off when signal Sᵢ is in a first state, for example, the low state, noted “0”, and switch SWᵢ is on when signal Sᵢ is in a second state, for example, the high state, noted “1”.

Each switch SWᵢ is, for example, a switch comprising at least one transistor, particularly a field-effect metal-oxide gate transistor or enrichment (normally on) or depletion (normally off) MOS transistor. According to an embodiment, each switch SWᵢ comprises a MOS transistor, for example, having an N channel, having its drain coupled to the cathode of general light-emitting diode Dᵢ, having its source coupled to node A₃, and having its gate receiving signal Sᵢ.

Optoelectronic circuit 20 comprises, for i varying from 1 to N−1, a current sensor 36ᵢ, provided between node A₃ and switch SWᵢ, delivering a signal CURᵢ to control unit 34. Optoelectronic circuit 20 further comprises a current sensor 36_{N} provided between node A₃ and the cathode of general light-emitting diode D_{N} and delivering a signal CUR_{N} to control unit 34. Further, optoelectronic circuit 20 comprises a voltage sensor 38 provided between current source 30 and node A₃ and delivering a signal VOLT to control unit 34.

According to an embodiment, for i varying from 1 to N, signal CURᵢ is representative of the intensity of current Iᵢ. According to another embodiment, signal CURᵢ indicates whether the intensity of current Iᵢ is greater than a current threshold, where the current threshold may be the same for each current Iᵢ or may be different according to the considered current Iᵢ.

According to an embodiment, signal VOLT is representative of voltage V_{CS}. According to another embodiment, signal VOLT indicates whether voltage V_{CS} is greater than a voltage threshold. Voltage sensor 36 may then comprise an operational amplifier assembled as a comparator supplying signal VOLT, having its non-inverting input connected to node A₃ and having its inverting input receiving the threshold voltage.

FIG. 6 shows an electric diagram of a more detailed embodiment of current source 30. In the present embodiment, current source 30 comprises an ideal current source 40 having a terminal connected to a source of a high reference potential VREF. The other terminal of current source 40 is connected to the drain of a diode-assembled N-channel MOS transistor 42. The source of MOS transistor 42 is connected to node A₂. The gate of MOS transistor 42 is connected to the drain of MOS transistor 42. High reference potential VREF may be supplied from voltage V_{ALIM} It may be constant or vary according to voltage V_{ALIM} The intensity of the current supplied by current source 30 may be constant or be variable, for example, it may vary according to voltage V_{ALIM}. Current source 30 comprises an N-channel MOS transistor 44 having its gate connected to the gate of transistor 42 and having its source connected to node A₂. The drain of transistor 44 is connected to node A₃, while voltage sensor 38 is not shown in FIG. 6. MOS transistors 42 and 44 form a current mirror which copies current I_{CS} supplied by current source 40, possibly with a multiplication factor.

FIG. 7 shows an embodiment of current sensor 36ᵢ where current sensor 36ᵢ comprises a resistor 46ᵢ series-assembled between node A₃ and switch SWᵢ, shown in FIG. 7 as a MOS transistor, and an operational amplifier 48ᵢ assembled as a comparator supplying signal CURᵢ, having its non-inverting input (+) connected to a terminal of resistor 46ᵢ and having its inverting input (−) connected to the other terminal of resistor 46ᵢ. Amplifier 48ᵢ comprises a terminal for setting offset voltage V_{offset}, or reference voltage, of the amplifier. Amplifier 48ᵢ supplies signal CURᵢ in a first state when the voltage across resistor 46ᵢ is greater than offset voltage V_{offset} and in a second state when the voltage across resistor 46ᵢ is smaller than offset voltage V_{offset}.

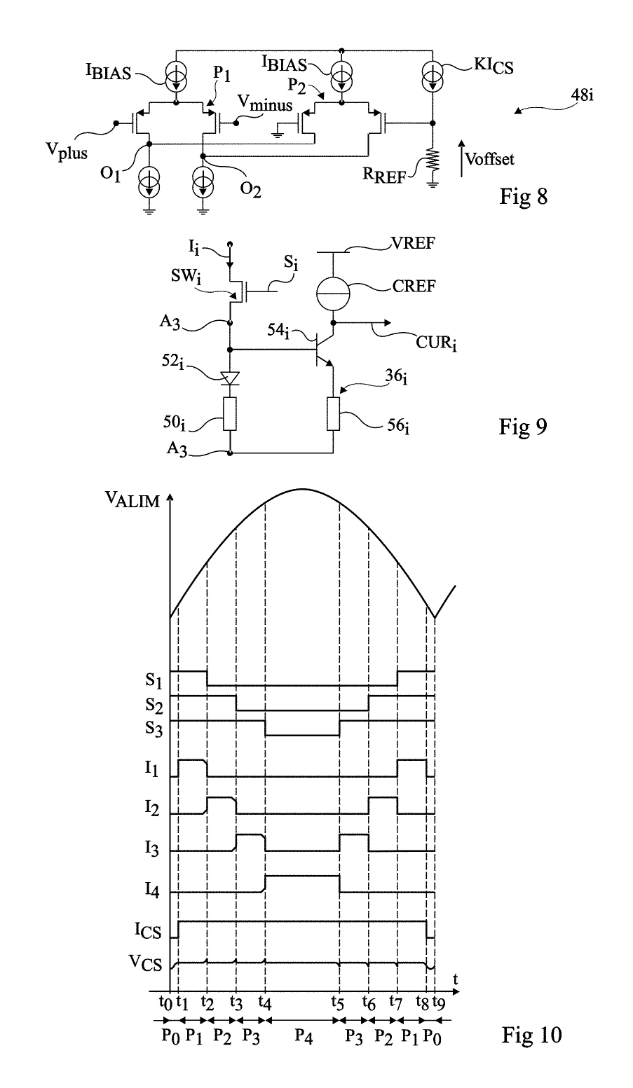

FIG. 8 shows a more detailed embodiment of comparator 48ᵢ and of a circuit supplying reference voltage V_{offset}. Comparator 48ᵢ comprises a first differential pair P₁, for example comprising two MOS transistors powered with a current I_{BIAS} and which detects the current flowing through resistor 46ᵢ, not shown in FIG. 8 and located between gates Vₚₗᵤₛ and Vₘᵢₙᵤₛ of the transistors of pair P₁. Nodes O₁ and O₂ are connected to the drains of the transistors of pair P₁. Comparator 48ᵢ comprises a second differential pair P₂, for example comprising two MOS transistors supplied with a current I_{BIAS} and which outputs reference voltage V_{offset} Nodes O₁ and O₂ are further connected to the drains of the transistors of pair P₂. Reference voltage V_{offset} is proportional to a bias current KI_{CS}, which is an image of the current I_{CS} supplied by current source 30, to the resistance of resistor R_{REF} having conducted the previous current, and to the transconductance ratio of the different pairs. An amplifier output stage connected to nodes O₁ and O₂ delivers a signal at a state “1” or “0” according to the sign of the voltage between nodes O₁ and O₂.

According to another embodiment, the current sensor may comprise a current mirror. Only a small fraction of the current flowing through switch SWᵢ is then branched towards a current comparator.

FIG. 9 shows another embodiment of current sensor 36ᵢ, where current sensor 36ᵢ comprises a resistor 50ᵢ and a diode 52ᵢ series-assembled between node A₃ and switch SWᵢ, shown in FIG. 9 as a MOS transistor, the cathode of diode 52ᵢ being connected to resistor 50ᵢ. Current sensor 36ᵢ further comprises a bipolar transistor 54ᵢ having its base connected to the anode of diode 52ᵢ, having its collector supplying signal CURᵢ, and having its emitter connected to node A₃ by a resistor 56ᵢ. The collector of bipolar transistor 54ᵢ is connected to a terminal of a source of a reference current CREF having its other terminal connected to the source of reference voltage VREF.

Advantageously, the maximum voltages applied to the electronic components, particularly the MOS transistors, of current sensors 36ᵢ and of voltage sensor 38 remain small as compared with the maximum value that voltage V_{ALIM} can take. It is then not necessary to provide, for current sensors 36ᵢ and current sensor 38, electronic components capable of withstanding the maximum voltage that voltage V_{ALIM} can take.

Optoelectronic circuit 20 operates as follows. At the beginning of a rising phase of voltage V_{ALIM}, switches SWᵢ, with i varying from 1 to N−1, are on, that is, electrically conductive. In a rising phase, for i varying from 1 to N−1, while general light-emitting diodes D₁ to Dᵢ₋₁ are conductive and general light-emitting diodes Dᵢ to D_{N} are non-conductive, when the voltage across general light-emitting diode Dᵢ becomes greater than the threshold voltage of general light-emitting diode Dᵢ, the latter becomes conductive and a current starts flowing through general light-emitting diode Dᵢ. The flowing of the current is detected by current sensor 36ᵢ. Unit 34 then controls switch SWᵢ₋₁ to the off state. At the beginning of a falling phase of power supply voltage V_{ALIM}, switches SWᵢ, with i varying from 1 to N−1, are off. In a falling phase, general light-emitting diodes D ₁ to Dᵢ₋₁ being conductive and general light-emitting diodes Dᵢ to D_{N} being non-conductive, when voltage V_{CS} decreases below a voltage threshold, this means that the voltage across current source 30 risks being too low for the latter to operate properly and to deliver its nominal current. This thus means that the number of conducting diodes Dᵢ should be decreased to increase the voltage across the current source. The decrease of voltage V_{CS} is detected by sensor 38 and switch SWᵢ₋₁ is then turned on. In the case where each switch SWᵢ is made of an N-channel MOS transistor having its drain coupled to the cathode of general light-emitting diode Dᵢ and having its source connected to current sensor 36ᵢ, when power supply voltage V_{ALIM} decreases, the voltage between the drain of switch SWᵢ and node A₂ decreases until the operation of transistor SWᵢ switches from the saturation state to the linear state. This causes an increase of the voltage between the gate and the source of transistor SWᵢ and thus a decrease of voltage V_{CS}. When voltage V_{CS} decreases below the voltage threshold, switch SWᵢ₋₁ is turned on.

Advantageously, the embodiment of the previously-described method of controlling switches SWᵢ does not depend on the number of elementary light-emitting diodes which form each general light-emitting diode Dᵢ and thus does not depend on the threshold voltage of each general light-emitting diode.

FIG. 10 shows timing diagrams of power supply voltage V_{ALIM}, of signals Sᵢ, with i varying from 1 to N−1, of currents Iᵢ, with i varying from 1 to N, of current I_{CS}, and of voltages V_{CS} illustrating the operation of optoelectronic circuit 20 according to the embodiment shown in FIG. 3, in the case where N is equal to 4 and in the case where each general light-emitting diode Dᵢ comprises the same number of elementary light-emitting diodes arranged in the same configuration, and thus has the same threshold voltage Vled and in the case where current source 30 supplies a constant current I_{CS}. Call t₀ to t₉ successive times.

At time t₀, at the beginning of a cycle, all switches SWᵢ, with i varying from 1 to N−1, are on (signals Sᵢ at “1”). Voltage V_{ALIM} rises from the zero value. Voltage V_{ALIM} being smaller than threshold voltage Vled of general light-emitting diode D₁, there is no light emission (phase P₀). Current I_{CS} is equal to zero.

At time t₁, when the voltage across general light-emitting diode D₁ exceeds threshold voltage Vled, general light-emitting diode D₁ becomes conductive (phase P₁) and the voltage across general light-emitting diode D₁ then remains substantially constant and equal to Vled. As soon as voltage V_{CS} is sufficiently high to allow the activation of current source 30, current I_{CS} flows through the general light-emitting diode D₁, which emits light. Current I_{CS} entirely flow through the branch comprising switch SW₁ and current I₁ is equal to I_{CS}. As an example, voltage V_{CS} is preferably substantially constant when current source 30 is in operation. In FIG. 10, it has been assumed that current source 30 is activated before general light-emitting diode D₁ becomes conductive so that current I_{CS} flows through general light-emitting diode D₁ from as soon as time t₁.

During the increase of voltage V_{ALIM}, when the voltage across general light-emitting diode D₂ exceeds threshold voltage Vled, general light-emitting diode D₂ becomes conductive and current I_{CS} is distributed between the branch containing switch SW₁ and the branch containing switch SW₂. A slight temporary increase of voltage V_{CS} can then be observed. Current I₁ decreases and current I₂ increases. When, at time t₂, current I₂ exceeds the current threshold, unit 34 controls switch SW₁ to the off state (signal Si set to “0”). Current I₁ becomes equal to zero and current I₂ increases up to I_{CS}. Phase P₂ corresponds to a phase of light emission by general light-emitting diodes D₁ and D₂.

Generally, during a rising phase of power supply voltage V_{ALIM}, for i varying from 1 to N−1, while switches SW₁ to SWᵢ₋₁ are off and switches SWᵢ to SW_{N-1} are on, unit 34 controls switch SWᵢ to the off state when current Iᵢ₊₁ flowing through the branch containing switch SWᵢ₊₁ exceeds the current threshold. Phase Pᵢ₊₁ corresponds to the emission of light by general light-emitting diodes D₁ to Dᵢ₊₁.

Thus, at time t₃, unit 34 controls switch SW₂ to the off state by the setting to “0” of signal S₂ and at time t₄, unit 34 controls switch SW₃ to the off state by the setting to “0” of signal S₃.

Power supply voltage V_{ALIM} reaches its maximum value during phase P₄ and starts a falling phase.

At time t₅, during the decrease of voltage V_{ALIM}, voltage V_{CS} decreases below the voltage threshold, unit 34 then controls switch SW₃ to the on state by the setting to “1” of signal S₃. Current I_{CS} then entirely flows through the branch containing switch SW₃. Current I₄ thus takes a zero value and current I₃ becomes equal to I_{CS}.

Generally, during a falling phase of power supply voltage V_{ALIM}, for i varying from 1 to N−1, while switches SW₁ to SWᵢ₋₁ are off and switches SWᵢ to SW_{N-1} are on, when voltage V_{CS} decreases below the voltage threshold, unit 34 controls switch SWᵢ₋₁ to the on state.

Thus, at time t₆, unit 34 controls switch SW₂ to the on state by the setting to “1” of signal S₂ and, at time t₇, unit 34 controls switch SW₁ to the on state by the setting to “1” of signal S₁.

At time t₈, the voltage across general light-emitting diode D₁ falls below voltage Vled. General light-emitting diode D₁ is then no longer conductive and current I₁ falls to zero.

At time t₉, voltage V_{ALIM} becomes equal to zero, which ends the cycle.

In the previously-described embodiments, in a rising phase, when light-emitting diode Dᵢ₊₁ becomes conductive while light-emitting diode Dᵢ is already conducting and switch SWᵢ is still on, the current is distributed in the branch comprising light-emitting diode Dᵢ₊₁ and the branch comprising light-emitting diode Dᵢ. A temporary slight increase of voltage V_{CS}, not shown in the drawings, can then be observed. When switch SWᵢ is off, current I_{CS} entirely flows through the branch comprising light-emitting diode Dᵢ₊₁. A temporary slight increase of voltage V_{CS} can then be observed. However, this decrease should not be detected by comparator 38 and cause the turning on of switch SWᵢ by control unit 34. According to an embodiment, the optoelectronic circuit is sized, particularly by an adapted selection of the detection threshold of comparison unit 38 and of the properties of switches Sᵢ and of the assemblies of light-emitting diodes Dᵢ, so that the temporary decrease of voltage V_{CS} is sufficiently small not to be detected by comparison unit 38. According to another embodiment, control unit 34 is capable of not taking into account a detection of a decrease of voltage V_{CS} by comparison unit 38 during a rising phase of voltage V_{ALIM}. This may be achieved by a temporary deactivation of comparison unit 38 for each rising phase or for a determined time period after each turning off of a switch SWᵢ.

According to an embodiment, current source 30 is a current source controlled by control unit 34 and capable of supplying a current I_{CS} which remains uninterrupted as long as power supply voltage V_{ALIM} is greater than the threshold voltage of general light-emitting diode D₁. According to an embodiment, current source 30 is capable of supplying a variable current at different levels according to the number of general light-emitting diodes which are conductive.

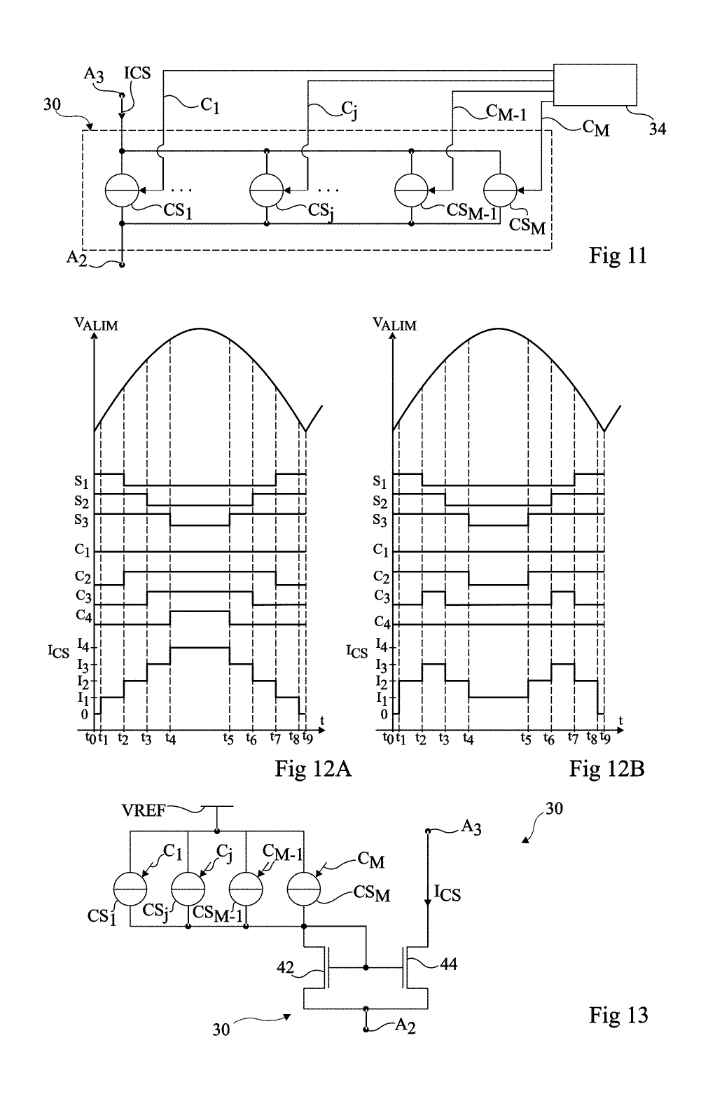

FIG. 11 shows an embodiment of current source 30 where current source 30 comprises M elementary controllable current sources CS₁ to CS_{M}, M being an integer capable of varying from 1 to N. Preferably, M is equal to N. In the present embodiment, elementary current sources CSⱼ, with j varying from 1 to M, are assembled in parallel between node A₃ and node A₂. Each elementary current source CSⱼ is activated or deactivated by control unit 34 by means of a control signal Cⱼ. As an example, signal Cⱼ is a binary signal and elementary current source CSⱼ is off when signal Cⱼ is in a first state, for example, the low state, and current source CSⱼ is activated when signal Cⱼ is in a second state, for example, the high state. As a variation, signal C₁ may be omitted and current source CS₁ may be automatically activated, that is, it supplies a current as soon as it is powered with a sufficient voltage.

The larger the number of current sources CSⱼ which are activated, the higher the intensity of current I_{CS}. According to an embodiment, the number of elementary current sources CSⱼ which are activated depends on the number of general light-emitting diodes Dᵢ which are conductive. According to an embodiment, current source 30 is capable of supplying a current I_{CS} having an intensity at a level among a plurality of constant levels and having its level depending on the number of general light-emitting diodes which are conductive. The currents supplied by elementary current sources CSⱼ of current source 30 may be identical or different. According to an embodiment, each elementary current source CSⱼ is capable of supplying a current of intensity I*2^{j-1}. Current source 30 is then capable of supplying a current having an intensity I_{CS} which may, according to control signals Cⱼ, take any value k*I, with k varying from 0 to 2^{M}−1.

The sequence of activation of current sources CSⱼ during the variation of voltage V_{ALIM} particularly depends on the operating properties of the optoelectronic circuit which are desired to be favored.

FIG. 12A illustrates an embodiment of a sequence of activation of the current sources which enables to increase the power factor of the optoelectronic circuit as compared with the case where the current would be constant. FIG. 12A shows curves of the variation of signals S₁, S₂ and S₃, curves of the variations of signals C₁, C₂, C₃ and C₄, and of current I_{CS} when optoelectronic circuit 20 comprises four general light-emitting diodes and four elementary current sources CSⱼ in parallel, during a cycle of voltage V_{ALIM} in the case where voltage V_{IN} is a sinusoidal voltage. The control of signals S₁, S₂ and S₃ is identical to what has been previously described in relation with FIGS. 10 and I₁, I₂, I₃ and I₄ are increasing intensity values of current I_{CS}.

According to an embodiment, at the beginning of a rising phase of voltage V_{ALIM}, signals Sᵢ, with i varying from 1 to N−1, are initially at “1” so that switches SWᵢ are on. Signal C₁ is at “1” so that current source CS₁ is activated. At time t₁, general light-emitting diode D₁ turns on and conducts current I_{CS} having an intensity equal to I₁. Switches SW₁, SW₂, and SW₃ are successively turned off at times t₁, t₂, and t₃ along the rise of voltage V_{ALIM} so that general light-emitting diodes D₂, D₃, and D₄ are successively powered with current. In parallel, current sources CS₂, CS₃ and CS₄ are successively activated at times t₂, t₃, and t₄ along the rise of voltage V_{ALIM}, so that the intensity of power supply current I_{CS} is successively equal to I₂, I₃ and I₄. During a falling phase of voltage V_{ALIM}, switches SW₃, SW₂, and SW₁ are successively turned on at times t₅, t₆, and t₇ to successively short-circuit general light-emitting diodes D₄, D₃, and D₂. In parallel, during a falling phase of voltage V_{ALIM}, current sources CS₄, CS₃ and CS₂ are successively deactivated at times t₅, t₆, and t₇ so that the intensity of power supply current I_{CS} is successively equal to I₃, I₂ and I₁. At time t₈, when the power supply voltage becomes smaller than the threshold voltage of general light-emitting diode D₁, current I_{CS} takes a zero value.

In this embodiment, the current sources are activated so that power supply current ICS follows as best as possible the general shape of a sine wave, that is, the shape of voltage V_{ALIM}, in phase therewith. Advantageously, the power factor of the optoelectronic circuit is then increased.

FIG. 12B is similar to FIG. 12A and illustrates an embodiment of a sequence of activation of the current sources, which enables to decrease the flickering perceived by an observer. The curves of FIG. 12B have been obtained with the optoelectronic circuit used to obtain the curves of FIG. 12A, with the difference that the current source activation sequence is modified. Indeed, signals C₁ and C₂ are initially at “1” and signals C₃ and C₄ are initially at “0” so that current sources CS₁ and CS₂ are activated and, at time t₁, the intensity of current I_{CS} flowing through general light-emitting diode D₁ is equal to I₂. At time t₂, signal C₃ is set to “1” so that the intensity of current I_{CS} flowing through general light-emitting diodes D₁ and D₂ is equal to I₃. At time t₃, signal C₃ is set to “0” so that the intensity of current I_{CS} flowing through general light-emitting diodes D₁, D₂, and D₃ is equal to I₂. At time t₄, signal C₂ is set to “0” so that the intensity of current I_{CS} flowing through general light-emitting diodes D₁, D₂, D₃, and D₄ is equal to I₁. A symmetrical activation sequence is carried out at times t₅, t₆, t₇, and t₈. The intensity of the current is controlled so that the emission light power of the optoelectronic circuit is close to the average light power emitted over a halfwave of voltage V_{ALIM} The variations of the light power perceived by the observed are then decreased.

According to an embodiment, the values of control signals Cⱼ may be stored in a memory of control unit 34 for each switching configuration of the switches.

According to another embodiment, the control of current source 30 by control unit 34 may be modified during the operation of the optoelectronic circuit, for example, according to whether it is desirable to increase the power factor of the optoelectronic circuit or to decrease the flickering perceived by an observer. In the case where current source 30 comprises elementary current sources CSⱼ, this means that the sequence of activation of elementary current sources CSⱼ may be modified during the operation of the optoelectronic circuit. As an example, the optoelectronic circuit may be made in the form of an integrated circuit comprising a dedicated pin having a control signal of control unit 34 representative of the desired control of current source 30 applied thereto. According to another example, control unit 34 comprises a memory programmable by a user, having data used by control unit 34 for the desired control of current source 30 by control unit 34 stored therein.

FIG. 13 shows an electric diagram of another embodiment of current source 30. In the present embodiment, current source 30 comprises transistors 42 and 44 forming the current mirror previously described in relation with FIG. 6. Current source 30 further comprises current sources CS₁ to CS_{M} which are assembled in parallel between a source of reference voltage VREF and the drain of transistor 42.

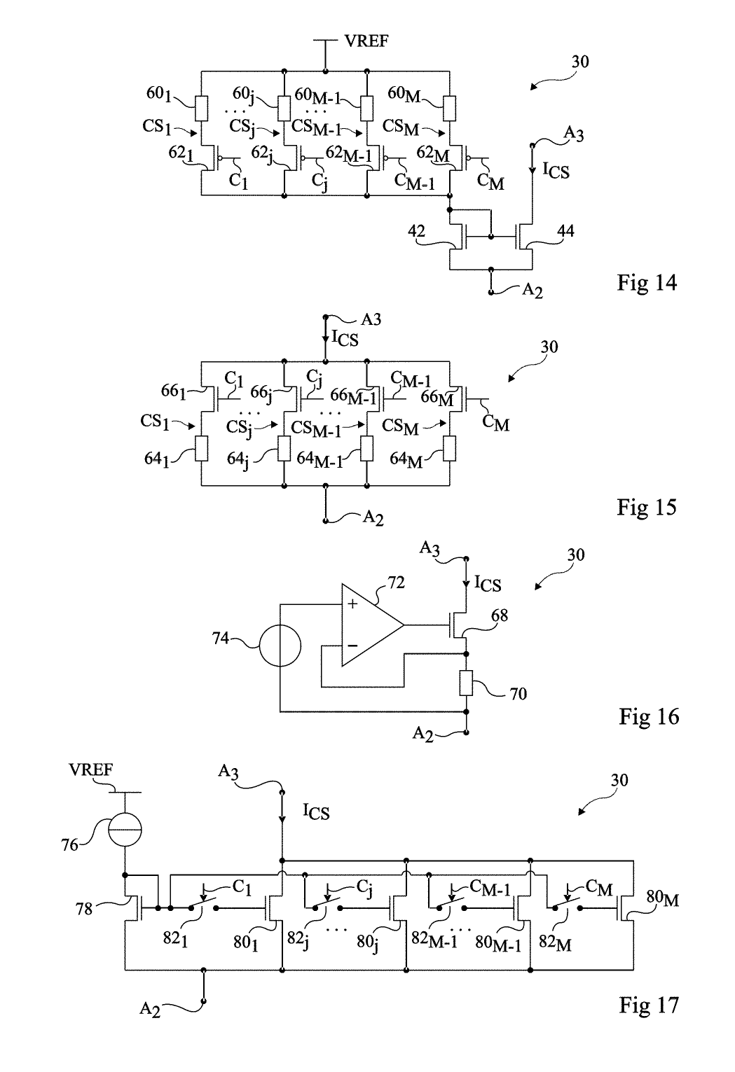

FIG. 14 shows an electric diagram of another embodiment of current source 30 where current source 30 comprises the same elements as the embodiment shown in FIG. 13 and where each current source CSⱼ, with j varying from 1 to M, comprises a resistor 60ⱼ series-assembled with a MOS transistor 62ⱼ, for example, with a P channel, between the source of reference potential VREF and the drain of transistor 42. The gate of each transistor 62ⱼ receives control signal Cⱼ. Preferably, each transistor 62ⱼ is located on the side of transistor 42 while each resistor 60ⱼ is located on the side of the source of reference voltage VREF.

FIG. 15 shows an electric diagram of another embodiment of current source 30 where current source 30 comprises the same elements as the embodiment shown in FIG. 11 and where each current source CSⱼ, with j varying from 1 to M, comprises a resistor 64ⱼ series-assembled with a MOS transistor 66ⱼ, for example, with an N channel, between node A₃ and node A₂. The gate of each transistor 66ⱼ receives control signal Cⱼ. Each transistor 66ⱼ is preferably located on the side of node A₃ while each resistor 64ⱼ is preferably located on the side of node A₂.

FIG. 16 shows an electric diagram of another embodiment of current source 30 where current source 30 comprises a MOS transistor 68, for example, with an N channel, having its drain connected to node A₃ and having its source connected to a terminal of a resistor 70, the other terminal of resistor 70 being connected to node A₂. Current source 30 comprises an operational amplifier 72 having its non-inverting input (+) connected to a terminal of a voltage source 74 controlled by control unit 34 and having its inverting input (−) connected to the junction point of transistor 68 and of resistor 70. The other terminal of voltage source 74 is connected to node A₂. The output of operational amplifier 72 is connected to the gate of transistor 68.

FIG. 17 shows an electric diagram of another embodiment of current source 30 where current source 30 comprises a current source 76 having a terminal connected to the source of reference potential VREF. The other terminal of current source 76 is connected to the drain of a diode-assembled MOS transistor 78, for example, having an N channel. The source of MOS transistor 78 is connected to node A₂. The gate of MOS transistor 78 is connected to the drain of MOS transistor 78. Current source 30 further comprises M MOS transistors 80ⱼ, with j varying from 1 to M, for example, having an N channel. The source of each transistor 80ⱼ is connected to node A₂. The drain of each transistor 80ⱼ is connected to node A₃. The gate of each transistor 80ⱼ is connected to the gate of transistor 78 via a switch 82ⱼ. Each switch 82ⱼ is controlled by control signal Cᵢ supplied by control unit 34. As a variation, switch 82₁ may be omitted. Each transistor 80ⱼ forms a current mirror with transistor 78. The intensity of current I_{CS} depends on the number of switches 82ⱼ which are on. According to an embodiment, each transistor 80ⱼ is identical to transistor 78. When switch 82ⱼ is on, transistor 80ⱼ conducts a current having the same intensity as the current supplied by current source 76 and is equivalent to elementary current source CSⱼ. According to another embodiment, the dimensions of transistors 80ⱼ may be different from those of transistor 78 and may be different between transistors 80ⱼ so that the intensity of the current flowing through each transistor 80ⱼ, when the associated switch 82ⱼ is on, is different from the intensity of the current supplied by current source 76. As an example, the intensity of the current flowing through each transistor 80ᵢ, when the associated switch 82ⱼ is on, is equal to the product of a different power of two and of a reference intensity.

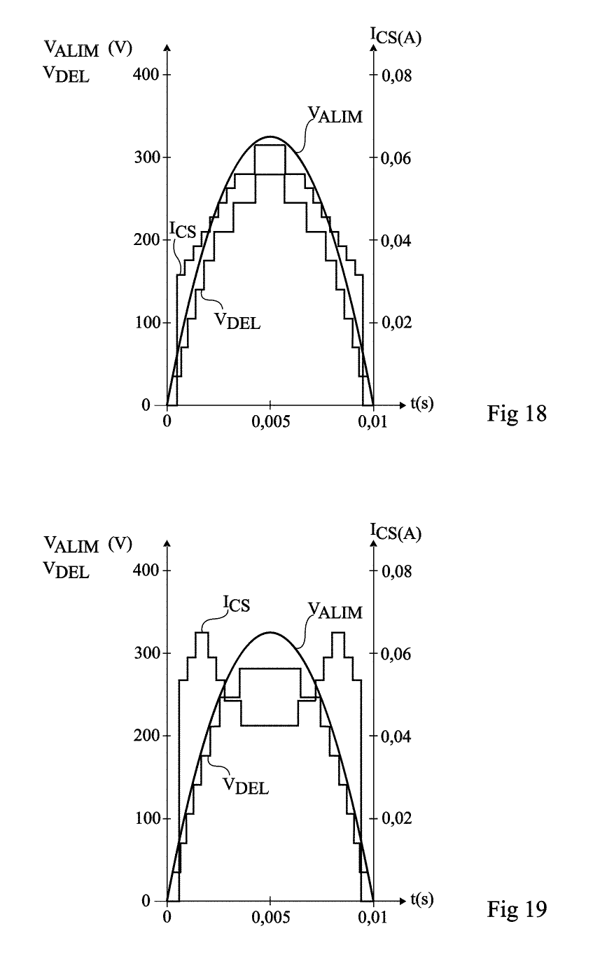

FIGS. 18 and 19 show curves of the variation, obtained by simulation during a cycle of voltage V_{ALIM} in the case where voltage V_{IN} is a sinusoidal voltage, of power supply voltage V_{ALIM}, of current I_{CS}, and of a voltage V_{DEL} equal to the sum of the voltages across the general light-emitting diodes which are conductive, when optoelectronic circuit 20 comprises eight general light-emitting diodes and eight elementary light-emitting diodes CSⱼ in parallel. Each elementary current source CSⱼ is capable of supplying a constant current of same intensity.

Calling Pₗᵤₘ the instantaneous light power supplied by the optoelectronic circuit and P_{lumMOY} the average of the light power over a cycle of voltage V_{ALIM}, flicker index FI is defined by the following relation (1):

$$FI = \frac{{\int }_{cycle} ( {P}_{lum} ( t ) - {P}_{lumMOY} ) d t}{{\int }_{cycle} {P}_{lum} d t} \qquad ( 1 )$$

FIG. 18 has been obtained with a sequence of activation of the elementary current sources of current source 30 similar to what has been previously described in relation with FIG. 12A. The average active power consumed by the optoelectronic circuit is 10.55 W, the power factor is 0.99, and flicker index FI is substantially equal to 33. The power factor is substantially equal to 1. Advantageously, the optoelectronic circuit further fulfills the constraints relative to harmonic currents provided for class-D and class-C lighting equipment by standard NF EN 61000-3-2, November 2014 version, regarding electromagnetic compatibility.

FIG. 19 has been obtained for a sequence of activation of the elementary current sources of current source 30 similar to what has been previously described in relation with FIG. 12B. The average active power consumed by the optoelectronic circuit is 10.58 W, the power factor is substantially equal to 0.89, and flicker index FI is substantially equal to 22. The flicker index is decreased with respect to the case illustrated in FIG. 18. The optoelectronic circuit further fulfills the constraints relative to harmonic currents provided for class-D lighting equipment, that is, equipment receiving an active power smaller than 25 W, by standard NF EN 61000-3-2, November 2014 version, regarding electromagnetic compatibility.

According to an embodiment, the optoelectronic circuit is capable of receiving a modulation signal external to the optoelectronic circuit and current source 30 can modify the intensity values of current I_{CS} according to the modulation signal. As an example, the optoelectronic circuit may comprise a terminal dedicated to receiving the modulation signal. The modulation signal can be received by control unit 34 which accordingly controls current source 30. The modulation signal may correspond to a voltage. Current source 30 is capable of modulating each intensity value between 0% and 100% according to the modulation signal. According to an embodiment, the modulation signal may be provided by a dimmer, particularly a dimmer capable of being actuated by a user. The modulation of the intensity values may be static, dynamic, and digital, or dynamic and analog. According to another embodiment, the modulation signal may be supplied by a luminosity sensor and control unit 34 may control current source 30 to modulate the current intensity values, for example, to take into account variations of the ambient luminosity and/or variations of the light emitted by the general light-emitting diodes according to temperature. Preferably, the modulation due to the modulation signal holds the priority and the modulation rate is the same for each intensity value of current I_{CS} supplied by current source 30.

Various embodiments with various variations have been described hereabove. It should be noted that those skilled in the art may combine these various embodiments and variations without showing any inventive step. In particular, each embodiment of current source 30 previously described in relation with FIGS. 13 to 17 may be used for the implementation of the embodiments of the current source control methods previously described in relation with FIGS. 12A and 12B.

1. An optoelectronic circuit intended to receive a variable voltage containing an alternation of rising and falling phases, the optoelectronic circuit comprising:
a plurality of assemblies of light-emitting diodes, said assemblies being series-assembled;
a current source connected to each assembly, among at least certain assemblies from the plurality of assemblies, by a switch;
for each switch, a first comparison unit capable of comparing the current flowing through the switch with a current threshold;
a second unit for comparing a voltage representative of the voltage across the current source with a voltage threshold; and
a control unit connected to the first and second comparison units and capable, during each rising phase and each falling phase, of controlling the switches to the off and on state according to signals supplied by the first and second comparison units.

2. The optoelectronic circuit of claim 1, wherein the control unit is capable, during each rising phase, for each switch, of controlling said switch to the off state when the current flowing through the adjacent switch in the on state rises above the current threshold and, during each falling phase, for each off switch adjacent to a switch in the on state, of controlling said switch to the on state when said voltage falls below the voltage threshold.

3. The optoelectronic circuit of claim 1, wherein the current source is capable of supplying a current having its intensity depending on at least one control signal.

4. The optoelectronic circuit of claim 3, wherein the current source is capable of supplying a current having its intensity varying among a plurality of different intensity values according to the number of assemblies conducting said current during at least one rising or falling phase.

5. The optoelectronic circuit of claim 4, wherein the optoelectronic circuit is capable of receiving a modulation signal external to the optoelectronic circuit and the current source is capable of modifying said intensity values according to said modulation signal.

6. The optoelectronic circuit of claim 1, wherein the current source comprises elementary current sources assembled in parallel and capable of being activated and deactivated independently from one another.

7. The optoelectronic circuit of claim 6, wherein the elementary current sources are capable of supplying currents having the same intensity or having different intensities.

8. The optoelectronic circuit of claim 6, wherein the control unit is capable of activating at least one of the elementary current sources during at least one rising phase and is capable of deactivating at least one of the elementary current sources during at least one falling phase.

9. The optoelectronic circuit of claim 6, wherein one of the elementary current sources is capable of supplying a current having a given intensity and the other elementary current sources are capable of each supplying a current having an intensity equal to the product of a power of two and of said given intensity.

10. The optoelectronic circuit of claim 6, wherein the control unit is capable of controlling the switches to connect the assemblies of light-emitting diodes according to a plurality of connection configurations successively according to a first order during each rising phase of the variable voltage and a second order during each falling phase of the variable voltage and is capable of activating the elementary current sources according to a third order during each rising phase of the variable voltage and of deactivating the elementary current sources according to a fourth order during each falling phase of the variable voltage.

11. The optoelectronic circuit of claim 4, comprising a memory having a plurality of values of the control signal of the current source, each corresponding to the provision by the current source of said current having its intensity varying among said plurality of intensity values, stored therein.

12. The optoelectronic circuit of claim 4, comprising means for modifying the variation profile of the intensity of said current according to the number of assemblies conducting said current during at least one rising or falling phase.

13. A method of controlling a plurality of assemblies of light-emitting diodes, said assemblies being series-assembled and powered with a variable voltage, containing an alternation of rising and falling phases, each assembly among at least certain assemblies from the plurality of assemblies being connected to a current source by a switch, the method comprising the steps of:
for each switch, performing a first comparison of the current flowing through the switch with a current threshold;
performing a second comparison of a voltage representative of the voltage across the current source with a voltage threshold; and
during each rising phase and each falling phase, controlling the switches to the off and on state according to the first and second comparisons.

14. The method of claim 13, further comprising the step of:
during each rising phase, for each switch, turning off said switch when the current flowing through the adjacent switch in the on state rises above the current threshold and, during each falling phase, for each off switch adjacent to a switch in the on state, turning on said switch when said voltage rises above the voltage threshold.

15. The method of claim 13, wherein the current source comprises at least two elementary current sources assembled in parallel and wherein at least one of the elementary current sources is activated during at least one rising phase and at least one of the elementary current sources is deactivated during at least one falling phase.

16. The method of claim 15, wherein the current source comprises at least three elementary current sources assembled in parallel, wherein, for at least successive rising and falling phases, the number of activated elementary current sources increases from the beginning to the end of the rising phase and the number of activated elementary current sources decreases from the beginning to the end of the falling phase or wherein the number of activated elementary current sources increases and then decreases from the beginning to the end of the rising phase and the number of activated elementary current sources increases and then decreases from the beginning to the end of the falling phase.
